(19) United States
(12) Patent Application Publication
(10) Pub. No.: US 2012/0221347 A1
(43) Pub. Date: Aug. 30, 2012

(54) MEDICAL RECONCILIATION, COMMUNICATION, AND EDUCATIONAL REPORTING TOOLS

(76) Inventor: Bruce Reiner, Berlin, MD (US)

(21) Appl. No.: 13/403,529

(22) Filed: Feb. 23, 2012

Related U.S. Application Data
(60) Provisional application No. 61/457,311, filed on Feb. 23, 2011.

(51) Int. Cl. G06Q 50/22

(52) U.S. Cl. 705/2

(57) ABSTRACT

The present invention relates to electronic multi-disciplinary tools, which have the ability to record, track, analyze, and provide feedback to practitioners in a context and user-specific fashion. The invention includes three components—a reconciliation tool, a communication tool, and an educational tool, which can operate independently, or in combination with one another. The reconciliation tool creates reports through the automated extraction of historical and contemporaneous medical data, and clinical data, into the report, and requires user reconciliation of any data inconsistency.

### CROSS-REFERENCE TO RELATED APPLICATIONS

The present invention claims priority from U.S. Provisional Patent Application No. 61/457,311, filed Feb. 23, 2011, the contents of which are herein incorporated by reference in their entirety.

### BACKGROUND OF THE INVENTION

1. Field of the Invention

The present invention relates to electronic multi-disciplinary tools, which have the ability to record, track, analyze, and provide feedback to practitioners in a context and user-specific fashion. The tools would be customizable based upon the unique needs and preferences of each individual end-user, while maintaining internal checks and balances to ensure that significant clinical data is not overlooked. Such a system would provide a mechanism where disparate data (e.g., graphical, numerical, text, and imaging) could be longitudinally tracked and analyzed to ensure that appropriate clinical follow-up takes place in accordance with established best practice guidelines.

2. Description of the Related Art

In the current medical practice, healthcare practitioners are faced with the often competing demands of improving quality, patient safety, operational efficiency, and productivity. As quality/safety demands continue to escalate; practitioners and administrators are further challenged by increasing quantity and complexity of medical data. While computerized information system technologies (e.g., picture archival and communication system (PACS), Electronic Medical Record (EMR)) have improved the manner in which data is archived and transmitted, challenges remain as to how this data can be continuously tracked and analyzed, in order to avoid the oversight and/or omission of clinically important data, which has the potential to adversely affect clinical outcomes.

Once of the biggest technical challenges currently facing medical practitioners, administrators, technology producers, and payers is the integration of disparate medical databases. If data from one database does not effectively communicate with data from another database, then co-mingling and correlation of data is largely left up to the individual practitioner. A combination of time constraints, increased service demands, data overload, and inefficient workflow all have the potential to result in critical data being missed, forgotten, or ignored.

To illustrate the current dilemma, the following are a few commonplace examples that currently exist in everyday clinical practice.

In one example, a radiologist, is tasked with the interpretation of an abdominal pelvic CT scan. In the course of reviewing the imaging dataset, the radiologist makes a mental note of 8 abnormal findings, of variable clinical significance. After navigating through the imaging dataset using multiple computerized tool functions and applications, the radiologist now prepares to create a report. In the course of creating this report, the radiologist performs a final cursory review of the imaging dataset and describes in detail a list of positive (i.e., abnormal) and negative (i.e., normal) findings, which can in turn be used by the referring clinician for management/treatment guidance. Due to the size and complexity of the database, the radiologist omits one of the positive findings (e.g., lung nodule) from the final report, which in effect creates the impression that the visualized lung base is normal. After reviewing the CT report, the referring clinician determines a course of clinical action based upon the radiology report, their own clinical assessment, and other supporting clinical data (e.g., laboratory test).

The omission of the lung nodule from the radiology report could have no clinical impact if the nodule in question is benign and unrelated to active disease. On the other hand, if the nodule turns out to be clinically significant (e.g., tumor, infection), its absence from the report could result in delayed, ineffective, or missed treatment. The potentially negative impact of this “missed” finding could have been avoided had an automated system been in place for the radiologist which provides real-time feedback for the reconciliation of all “observed” and “reported” findings. This would in effect ensure that each “observed” finding (during the course of image review and interpretation) is accounted for in the final radiology report. At the same time, a direct linkage is needed between imaging and textual data, to provide the end-user with the ability to directly correlate the imaging and textual data for each reported finding.

In a second example, a primary care physician is reviewing a cardiology consultation report, in reference to one of his patients with worsening chest pain. In the course of the consultation note, a number of pertinent laboratory data is referenced, along with recommendations for additional clinical testing (e.g., echocardiography) and new pharmaceutical therapy. After reading the cardiology consultation note, the family physician places an order for the recommended clinical test and requests for the patient to have a follow-up appointment in his office in two weeks.

The patient misses the scheduled follow-up appointment due to a family emergency and is rescheduled a month later. During the course of the appointment, the physician reviews the results of the cardiology consultation, echocardiography, and laboratory data with the patient; who is reporting a mild reduction in symptoms, which she partly attributes to diminished stress. The family physician overlooks the recommendation for drug therapy provided in the cardiology consultation note and continues with the current treatment regimen. Several months later the patient experiences severe chest pain requiring hospitalization and cardiac catheterization. While the oversight in omitting the recommended drug treatment cannot be shown to be a direct cause of the acute event, it was believed to be in part attributable to the worsening in symptoms and delay in definitive treatment. In this example, the lack of an automated mechanism to track and analyze multiple data related to a clinical complaint or disease resulted in human error (i.e., data oversight) and the omission of recommended therapy.

In a third example, a patient is referred to an imaging department for a CT angiography of the brain in the evaluation of a suspected aneurysm. Following completion of the contrast injection, the patient experiences hives and itching, representative of an allergic reaction to the contrast. The technologist notifies the radiologist of the adverse event and documents the allergic reaction in the patient's exam information in the radiology information system (RIS).

The examination is not interpreted until the following day, at which time another radiologist is on duty. During the course of image review and interpretation, the radiologist reviews the imaging and clinical data available on the PACS and generates a report. Due to the fact that radiologist was not present at the time of the allergic reaction and the documented data is recorded in a separate database, no record of the allergic reaction is recorded in the final radiology report. The patient fails to mention the adverse event to the referring clinician, who therefore assumes that no further action is required, given the normal report findings. Several months later, the patient undergoes another contrast imaging exam (e.g., CT), at which time she experiences an anaphylactic reaction (i.e., shock).

This subsequent adverse clinical event could have been avoided had the appropriate data regarding the allergic reaction to intravenous contrast been recorded in the radiology report and documented in the patient's electronic medical record (EMR). In order to ensure this could have been accomplished, an effective mechanism is needed to capture the data recorded by the technologist in the RIS, and to have this mechanism present the information to both the radiologist (in the PACS) and referring clinician (in the EMR). In this scenario, the integration of radiology information system (RIS), PACS, and EMR data was essential to ensure that documentation was complete and readily available to all future healthcare providers.

The common thread for all three examples is that medical data in its current form is often subject to human oversight and omission, due to the lack of data integration, data standardization, and automated tracking tools. Thus, a method and apparatus is needed that creates a model for alleviating these oversights, by creating an electronic tool for data reconciliation, ensuring that all data deemed clinically relevant is recorded, tracked, analyzed, and presented for effective longitudinal diagnosis, treatment, and management.

### SUMMARY OF THE INVENTION

The present invention relates to electronic multi-disciplinary tools, which have the ability to record, track, analyze, and provide feedback to practitioners in a context and user-specific fashion. The tools would be customizable based upon the unique needs and preferences of each individual end-user, while maintaining internal checks and balances to ensure that significant clinical data is not overlooked. Such a system would provide a mechanism where disparate data (e.g., graphical, numerical, text, and imaging) could be longitudinally tracked and analyzed to ensure that appropriate clinical follow-up takes place in accordance with established best practice guidelines.

In one embodiment of the present invention, a computer-implemented method of providing a multi-disciplinary interface to a user of a medical computer system, includes: capturing an image on a display screen of a computer system, in which a clinical finding is contained; storing said image along with a descriptive textual presentation of said finding, in a report in a database of said computer system; wherein said stored image includes an annotation schema which is customized to preferences of the user; incorporating external data requirements from at least one of institutional requirements, community-based standards, and medical professionals in said report in said database; reconciling data within said report with data contained within separate reports from other separate databases to determine data consistency; and alerting the user using electronic communication means, of said data inconsistency and requesting reconciliation of said data inconsistency.

In one embodiment, the computer-implemented method further includes tracking data which is stored in any of said separate databases to determine consistency and accuracy between said separate databases.

In one embodiment, the computer-implemented method further includes recording prior imaging examination reports findings onto said report, along with any images, to create a new report.

In one embodiment, the prior imaging examination reports findings are automatically extracted and transposed onto said new report according to a predetermined relevance.

In one embodiment, the extraction is performed in real-time.

In one embodiment, the computer-implemented includes automatically transposing clinical data provided by a clinician and integrating said clinical data into said report.

In one embodiment, the clinical data is at least one of numerical, textual, photographic, and graphical.

In one embodiment, the computer-implemented method includes requiring the user to determine whether imaging examination report data received from an imaging examination, and stored in said database, addresses clinical indication data provided.

In one embodiment, the computer-implemented includes requiring reconciliation by the user when said imaging examination report data does not address said clinical indication data.

In one embodiment, the computer-implemented method includes allowing multiple end-users to import data into said report.

In one embodiment, the end-users include clinicians, technologists, nurses, and administrators.

In one embodiment, the computer-implemented method includes initiating consultation and communication with other users relative to said report.

In one embodiment, the computer-implemented method includes tracking, analyzing, and storing in said database, all said consultations and communications during a lifetime of said report.

In one embodiment, the computer-implemented method includes using electronic communication methods for communication to report critical results.

In one embodiment, the computer-implemented method includes sorting and analyzing said clinical data and said imaging examination report data according to said findings, and according to end-user profiles and end-user performance.

In one embodiment, the end-user profiles include classifications based upon occupational status, practice type, institutional characteristics and individual characteristics.

In one embodiment, a computer-readable medium is provided, whose contents cause a computer system to execute instructions of a program, the program including the steps of: capturing an image on a display screen of a computer system, in which a clinical finding is contained; storing said image along with a descriptive textual presentation of said finding, in a report in a database of said computer system; wherein said stored image includes an annotation schema which is customized to preferences of the user; incorporating external data requirements from at least one of institutional requirements, community-based standards, and medical professionals in said report in said database; reconciling data within said report with data contained within separate reports from other separate databases to determine data consistency; and alerting the user using electronic communication means, of said data inconsistency and requesting reconciliation of said data inconsistency.

In one embodiment, a computer system provides a multi-disciplinary interface to a user of a medical computer system, including: at least one memory containing at least one program including the steps of: capturing an image on a display screen of a computer system, in which a clinical finding is contained; storing said image along with a descriptive textual presentation of said finding, in a report in a database of said computer system; wherein said stored image includes an annotation schema which is customized to preferences of the user; incorporating external data requirements from at least one of institutional requirements, community-based standards, and medical professionals in said report in said database; reconciling data within said report with data contained within separate reports from other separate databases to determine data consistency; and alerting the user using electronic communication means, of said data inconsistency and requesting reconciliation of said data inconsistency; and at least one processor which executes the program.

Thus, there has been outlined, some features that are consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a schematic diagram which shows the overall components of the present invention.

FIG. 2 is a flowchart showing an overview of the reconciliation, communication, and educational tools of the present invention.

### DESCRIPTION OF THE INVENTION

The present invention relates to electronic multi-disciplinary tools, which have the ability to record, track, analyze, and provide feedback to practitioners in a context and user-specific fashion. The tools would be customizable based upon the unique needs and preferences of each individual end-user, while maintaining internal checks and balances to ensure that significant clinical data is not overlooked. Such a system would provide a mechanism where disparate data (e.g., graphical, numerical, text, and imaging) could be longitudinally tracked and analyzed to ensure that appropriate clinical follow-up takes place in accordance with established best practice guidelines.

The present invention includes a system of three components, which can operate independently, or in combination with one another. The computer program's central database drives all three components, and is created through the extraction of historical and contemporaneous medical data, which can take a number of forms including (but not limited to) graphical, imaging, textual, and numerical data. The sources of these data included in the databases are the various medical information systems technologies in current use including, but not limited to, the electronic medical record (EMR), hospital information system (HIS), and various departmental information systems (e.g., pharmacy information system, laboratory information system, radiology information system (RIS)), and picture archival and communication system (PACS)).

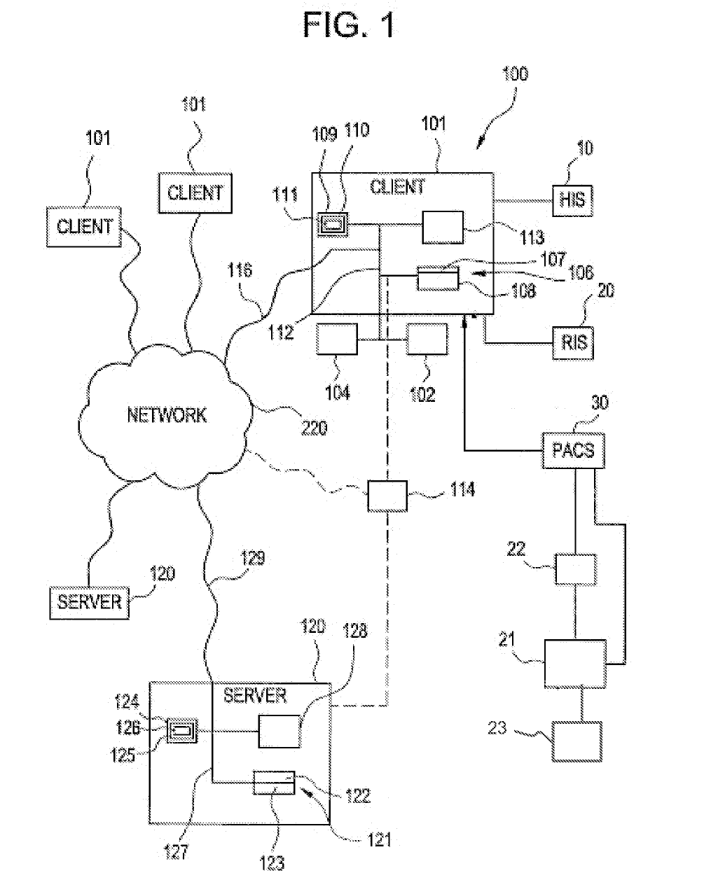

According to one embodiment of the invention illustrated in FIG. 1, medical (radiological) applications may be implemented using the system 100. The system 100 is designed to interface with existing information systems such as a Hospital Information System (HIS) 10, a Radiology Information System (RIS) 20, a radiographic device 21, and/or other information systems that may access a computed radiography (CR) cassette or direct radiography (DR) system, a CR/DR plate reader 22, a Picture Archiving and Communication System (PACS) 30, and/or other systems. The system 100 may be designed to conform with the relevant standards, such as the Digital Imaging and Communications in Medicine (DICOM) standard, DICOM Structured Reporting (SR) standard, and/or the Radiological Society of North America's Integrating the Healthcare Enterprise (IHE) initiative, among other standards.

According to one embodiment, bi-directional communication between the system 100 of the present invention and the information systems, such as the HIS 10, RIS 20, QA sensor device 21, CR/DR plate reader 22, and PACS 30, etc., may be enabled to allow the system 100 to retrieve and/or provide information from/to these systems. According to one embodiment of the invention, bi-directional communication between the system 100 of the present invention and the information systems allows the system 100 to update information that is stored on the information systems. According to one embodiment of the invention, bi-directional communication between the system 100 of the present invention and the information systems allows the system 100 to generate desired reports and/or other information.

The system 100 of the present invention includes a client computer 101, such as a personal computer (PC), which may or may not be interfaced or integrated with the PACS 30. The client computer 101 may include an imaging display device 102 that is capable of providing high resolution digital images in 2-D or 3-D, for example. According to one embodiment of the invention, the client computer 101 may be a mobile terminal if the image resolution is sufficiently high. Mobile terminals may include mobile computing devices, a mobile data organizer (PDA), or other mobile terminals that are operated by the user accessing the program 110 remotely.

According to one embodiment of the invention, an input device 104 or other selection device, may be provided to select hot clickable icons, selection buttons, and/or other selectors that may be displayed in a user interface using a menu, a dialog box, a roll-down window, or other user interface. The user interface may be displayed on the client computer 101. According to one embodiment of the invention, users may input commands to a user interface through a programmable stylus, keyboard, mouse, speech processing device, laser pointer, touch screen, or other input device 104, including eye tracking (see U.S. patent application Ser. No. 12/988,554, filed Jul. 18, 2011, the contents of which are herein incorporated by reference in their entirety).

According to one embodiment of the invention, the input or other selection device 104 may be implemented by a dedicated piece of hardware or its functions may be executed by code instructions that are executed on the client processor 106. For example, the input or other selection device 104 may be implemented using the imaging display device 102 to display the selection window with a stylus or keyboard for entering a selection.

According to another embodiment of the invention, symbols and/or icons may be entered and/or selected using an input device 104, such as a multi-functional programmable stylus. The multi-functional programmable stylus may be used to draw symbols onto the image and may be used to accomplish other tasks that are intrinsic to the image display, navigation, interpretation, and reporting processes, as described in U.S. patent application Ser. No. 11/512,199 filed on Aug. 30, 2006, the entire contents of which are hereby incorporated by reference. The multi-functional programmable stylus may provide superior functionality compared to traditional computer keyboard or mouse input devices. According to one embodiment of the invention, the multi-functional programmable stylus also may provide superior functionality within the PACS and Electronic Medical Report (EMR).

According to one embodiment of the invention, the client computer 101 may include a processor 106 that provides client data processing. According to one embodiment of the invention, the processor 106 may include a central processing unit (CPU) 107, a parallel processor, an input/output (I/O) interface 108, a memory 109 with a program 110 having a data structure 111, and/or other components. According to one embodiment of the invention, the components all may be connected by a bus 112. Further, the client computer 101 may include the input device 104, the image display device 102, and one or more secondary storage devices 113. According to one embodiment of the invention, the bus 112 may be internal to the client computer 101 and may include an adapter that enables interfacing with a keyboard or other input device 104. Alternatively, the bus 112 may be located external to the client computer 101. According to one embodiment of the invention, the image display device 102 may be a high resolution touch screen computer monitor. According to one embodiment of the invention, the image display device 102 may clearly, easily and accurately display images, such as x-rays, and/or other images. Alternatively, the image display device 102 may be implemented using other touch sensitive devices including tablet personal computers, pocket personal computers, plasma screens, among other touch sensitive devices. The touch sensitive devices may include a pressure sensitive screen that is responsive to input from the input device 104, such as a stylus, that may be used to write/draw directly onto the image display device 102.

According to another embodiment of the invention, high resolution goggles may be used as a graphical display to provide end users with the ability to review images. According to another embodiment of the invention, the high resolution goggles may provide graphical display without imposing physical constraints of an external computer. According to another embodiment, the invention may be implemented by an application that resides on the client computer 101, wherein the client application may be written to run on existing computer operating systems. Users may interact with the application through a graphical user interface. The client application may be ported to other personal computer (PC) software, personal digital assistants (PDAs), cell phones, and/or any other digital device that includes a graphical user interface and appropriate storage capability.

According to one embodiment of the invention, the processor 106 may be internal or external to the client computer 101. According to one embodiment of the invention, the processor 106 may execute a program 110 that is configured to perform predetermined operations. According to one embodiment of the invention, the processor 106 may access the memory 109 in which may be stored at least one sequence of code instructions that may include the program 110 and the data structure 111 for performing predetermined operations. The memory 109 and the program 110 may be located within the client computer 101 or external thereto.

While the system of the present invention may be described as performing certain functions, one of ordinary skill in the art will readily understand that the program 110 may perform the function rather than the entity of the system itself.

According to one embodiment of the invention, the program 110 that runs the system 100 may include separate programs 110 having code that performs desired operations. According to one embodiment of the invention, the program 110 that runs the system 100 may include a plurality of modules that perform sub-operations of an operation, or may be part of a single module of a larger program 110 that provides the operation.

According to one embodiment of the invention, the processor 106 may be adapted to access and/or execute a plurality of programs 110 that correspond to a plurality of operations. Operations rendered by the program 110 may include, for example, supporting the user interface, providing communication capabilities, performing data mining functions, performing e-mail operations, and/or performing other operations. According to one embodiment of the invention, the data structure 111 may include a plurality of entries. According to one embodiment of the invention, each entry may include at least a first storage area, or header, that stores the databases or libraries of the image files, for example.

According to one embodiment of the invention, the storage device 113 may store at least one data file, such as image files, text files, data files, audio files, video files, among other file types. According to one embodiment of the invention, the data storage device 113 may include a database, such as a centralized database and/or a distributed database that are connected via a network. According to one embodiment of the invention, the databases may be computer searchable databases. According to one embodiment of the invention, the databases may be relational databases. The data storage device 113 may be coupled to the server 120 and/or the client computer 101, either directly or indirectly through a communication network, such as a LAN, WAN, and/or other networks. The data storage device 113 may be an internal storage device. According to one embodiment of the invention, system 100 may include an external storage device 114. According to one embodiment of the invention, data may be received via a network and directly processed.

According to one embodiment of the invention, the client computer 101 may be coupled to other client computers 101 or servers 120. According to one embodiment of the invention, the client computer 101 may access administration systems, billing systems and/or other systems, via a communication link 116. According to one embodiment of the invention, the communication link 116 may include a wired and/or wireless communication link, a switched circuit communication link, or may include a network of data processing devices such as a LAN, WAN, the Internet, or combinations thereof. According to one embodiment of the invention, the communication link 116 may couple e-mail systems, fax systems, telephone systems, wireless communications systems such as pagers and cell phones, wireless PDA's and other communication systems.

According to one embodiment of the invention, the communication link 116 may be an adapter unit that is capable of executing various communication protocols in order to establish and maintain communication with the server 120, for example. According to one embodiment of the invention, the communication link 116 may be implemented using a specialized piece of hardware or may be implemented using a general CPU that executes instructions from program 110. According to one embodiment of the invention, the communication link 116 may be at least partially included in the processor 106 that executes instructions from program 110.

According to one embodiment of the invention, if the server 120 is provided in a centralized environment, the server 120 may include a processor 121 having a CPU 122 or parallel processor, which may be a server data processing device and an I/O interface 123. Alternatively, a distributed CPU 122 may be provided that includes a plurality of individual processors 121, which may be located on one or more machines. According to one embodiment of the invention, the processor 121 may be a general data processing unit and may include a data processing unit with large resources (i.e., high processing capabilities and a large memory for storing large amounts of data).

According to one embodiment of the invention, the server 120 also may include a memory 124 having a program 125 that includes a data structure 126, wherein the memory 124 and the associated components all may be connected through bus 127. If the server 120 is implemented by a distributed system, the bus 127 or similar connection line may be implemented using external connections. The server processor 121 may have access to a storage device 128 for storing preferably large numbers of programs 110 for providing various operations to the users.

According to one embodiment of the invention, the data structure 126 may include a plurality of entries, wherein the entries include at least a first storage area that stores image files. Alternatively, the data structure 126 may include entries that are associated with other stored information as one of ordinary skill in the art would appreciate.

According to one embodiment of the invention, the server 120 may include a single unit or may include a distributed system having a plurality of servers 120 or data processing units. The server(s) 120 may be shared by multiple users in direct or indirect connection to each other. The server(s) 120 may be coupled to a communication link 129 that is preferably adapted to communicate with a plurality of client computers 101.

According to one embodiment, the present invention may be implemented using software applications that reside in a client and/or server environment. According to another embodiment, the present invention may be implemented using software applications that reside in a distributed system over a computerized network and across a number of client computer systems. Thus, in the present invention, a particular operation may be performed either at the client computer 101, the server 120, or both.

According to one embodiment of the invention, in a client-server environment, at least one client and at least one server are each coupled to a network 220, such as a Local Area Network (LAN), Wide Area Network (WAN), and/or the Internet, over a communication link 116, 129. Further, even though the systems corresponding to the HIS 10, the RIS 20, the radiographic device 21, the CR/DR reader 22, and the PACS 30 (if separate) are shown as directly coupled to the client computer 101, it is known that these systems may be indirectly coupled to the client over a LAN, WAN, the Internet, and/or other network via communication links. According to one embodiment of the invention, users may access the various information sources through secure and/or non-secure internet connectivity. Thus, operations consistent with the present invention may be carried out at the client computer 101, at the server 120, or both. The server 120, if used, may be accessible by the client computer 101 over the Internet, for example, using a browser application or other interface.

According to one embodiment of the invention, the client computer 101 may enable communications via a wireless service connection. The server 120 may include communications with network/security features, via a wireless server, which connects to, for example, voice recognition. According to one embodiment, user interfaces may be provided that support several interfaces including display screens, voice recognition systems, speakers, microphones, input buttons, and/or other interfaces. According to one embodiment of the invention, select functions may be implemented through the client computer 101 by positioning the input device 104 over selected icons. According to another embodiment of the invention, select functions may be implemented through the client computer 101 using a voice recognition system to enable hands-free operation. One of ordinary skill in the art will recognize that other user interfaces may be provided.

According to another embodiment of the invention, the client computer 101 may be a basic system and the server 120 may include all of the components that are necessary to support the software platform. Further, the present client-server system may be arranged such that the client computer 101 may operate independently of the server 120, but the server 120 may be optionally connected. In the former situation, additional modules may be connected to the client computer 101. In another embodiment consistent with the present invention, the client computer 101 and server 120 may be disposed in one system, rather being separated into two systems.

Although the above physical architecture has been described as client-side or server-side components, one of ordinary skill in the art will appreciate that the components of the physical architecture may be located in either client or server, or in a distributed environment.

Further, although the above-described features and processing operations may be realized by dedicated hardware, or may be realized as programs having code instructions that are executed on data processing units, it is further possible that parts of the above sequence of operations may be carried out in hardware, whereas other of the above processing operations may be carried out using software.

The underlying technology allows for replication to various other sites. Each new site may maintain communication with its neighbors so that in the event of a catastrophic failure, one or more servers 120 may continue to keep the applications running, and allow the system to load-balance the application geographically as required.

Further, although aspects of one implementation of the invention are described as being stored in memory, one of ordinary skill in the art will appreciate that all or part of the invention may be stored on or read from other computer-readable media, such as secondary storage devices, like hard disks, floppy disks, CD-ROM, a carrier wave received from a network such as the Internet, or other forms of ROM or RAM either currently known or later developed. Further, although specific components of the system have been described, one skilled in the art will appreciate that the system suitable for use with the methods and systems of the present invention may contain additional or different components.

In the present invention, a multi-directional interface is provided which includes a program 110 to export various data between the individual information system databases (i.e., HIS, RIS, EMR, etc.) 113, 114 and become incorporated into the medical report being created on the computer system 100 by the user (i.e., radiologist). As an example, a radiologist creating an abdominal CT report could import relevant patient data from the EMR or laboratory information system (e.g., liver enzymes) and incorporate the data into the medical (i.e., radiology) report.

This integration of multi-disciplinary data can take a number of forms. One simplistic integration method would include linking textual concepts, such as the radiology report finding “fatty infiltration of the liver”, with the laboratory finding “elevated hepatic enzyme measurement (with corresponding numerical value). Another method for linking multi-disciplinary data within the radiology report is to link the report textual data (e.g., fatty infiltration of the liver), with the laboratory finding (e.g., elevated liver enzyme), and with the imaging data (e.g., specific CT image which shows the liver abnormality in question). If the patient was to undergo a surgical procedure specific to the data in question (e.g., surgical biopsy of the liver), the corresponding pathology report data could also be linked to the aforementioned data elements, thereby creating a co-mingling or integration of multi-disciplinary medical data which transcends the specific type, author, and chronology of data.

The first component of the present invention is the Reconciliation Tool, which includes a program 110 where the end-user (i.e., radiologist) can address a specific clinical question, correlate the data with historical data from databases 113, 114, and ensure that all data elements are accounted for in a newly created report.

In one example, an abdominal/pelvic CT is ordered by a clinician for a patient with known prostate cancer with recently elevated tumor markers (e.g., prostate-specific antigen (PSA)) and weight loss. In the course of conventional image review and interpretation, the radiologist navigates through the current CT imaging dataset and notes any abnormal findings (i.e., pathology); with a particular emphasis on those findings which may be related to the documented prostate cancer. At the same time, the radiologist needs to address the clinical indications prompting the examination, which are elevated prostate tumor markers and unexplained weight loss, which may or may not be related to one another. Another important responsibility for the radiologist is to review and correlate findings from prior (i.e., historical) imaging studies and determine what temporal change has taken place, along with the resulting clinical implications.

In the course of reviewing the current imaging dataset, the radiologist typically makes a mental note of the various anatomic structures, and differentiates normal from abnormal findings. Those findings which are determined to be abnormal (i.e., pathologic) are often referred to as “positive findings”, whereas those findings determined to be normal (i.e., physiologic) are referred to as “negative findings”. A comprehensive report by the radiologist would incorporate both “positive” and “negative” findings, and provide information regarding the clinical significance of these findings, on both an individual finding and collective finding basis.

One frequently encountered problem is that a complex imaging study may contain numerous pathologic findings, which can become “lost” in the transition from observation to reporting. During image review, the radiologist may make a mental note of eight (8) “positive” findings and include only seven (7) such findings in the report. As a result, one of the pathologic findings was erroneously converted from a “positive” to a “negative” finding by omission. This oversight has the potential to lead to delayed or misdiagnosis and an adverse clinical outcome.

One approach to avoid this error would be to have the radiologist report each individual “positive” finding at the time of initial observation, but this is often detrimental to workflow; and can lead to a fragmented analysis of the dataset. The preferred option would be to review the entire dataset in continuity, providing the reader with the ability to analyze all of the data simultaneously. This is particularly important when one considers that many disease processes are not isolated, but involve multiple organ systems. The ability of the present invention to reference multiple findings in a continuous and uninterrupted fashion has benefits to both workflow and analysis.

In the reporting strategy of the present invention, the end-user is provided by the program 110 with the ability to electronically mark or annotate various findings of interest (both positive and negative findings), as he/she navigates through the dataset. The ability to rapidly mark an anatomic region of interest would not significantly slow navigation through the dataset, nor disrupt the continuity in observation and analysis. The mark would simply serve as an electronic “place holder”, which can in turn be automatically recorded in the report for downstream completion. By converting each electronic mark or annotation to a report finding, no findings would be erroneously missed and reconciliation would be achieved between all “observed” and “reported” findings.

In the present invention, the input method used for this electronic mark-up would be variable and subject to multiple options. The most simplistic option would be manual input, which could take the form of a mouse or keyboard directed command, or be directed by an electronic stylus, etc. Speech input could also be used where the end-user would issue a verbal command which denotes the anatomic region of interest and/or finding in question. A third input option would be visual, where eye tracking could be used to record a finding (both positive and negative findings), using eye tracking systems currently available, which could be differentiated by the specific eye input command. Regardless of the input command used, the image which displays the finding of interest would be recorded and annotated by the program 110 in the database 113, 114, so that future review of the report would provide the option to simultaneously review the imaging and textual findings being reported.

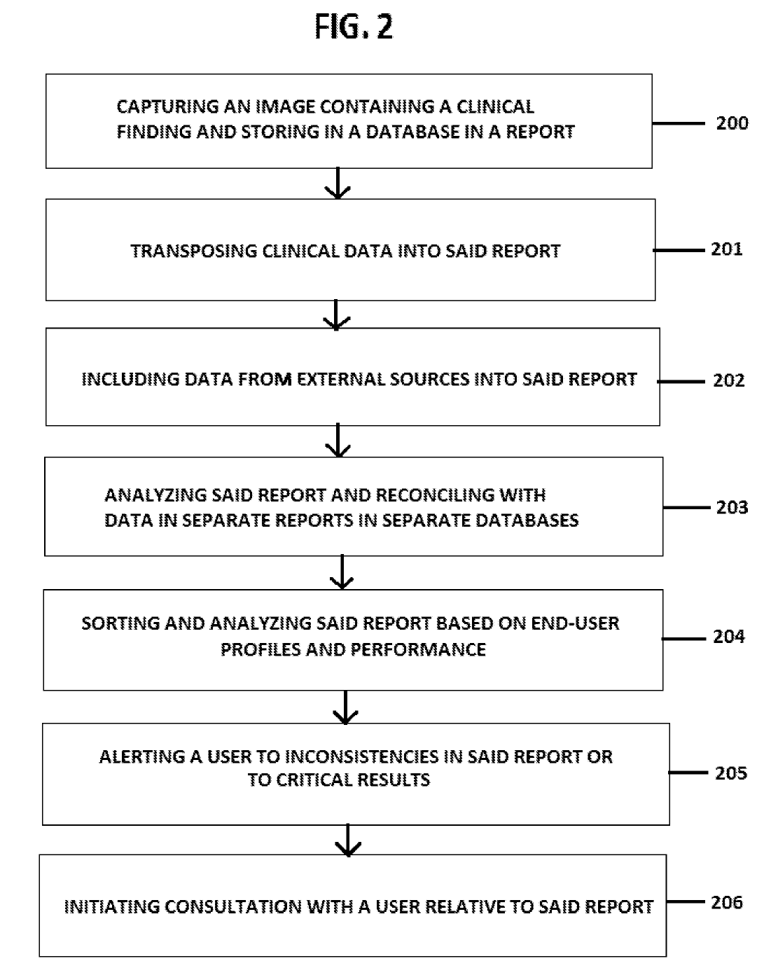

Each time a new finding is recorded by the program 110 in the database 113, 114, two simultaneous events take place. The first is the capture by the program 110, of the individual image on the display screen, in which the finding is contained, and the second is the recording of the finding in both imaging and textual presentation states, in the database 113, 114 (see FIG. 2, step 200), by the program 110. The imaging presentation includes an annotation schema, which can be customized by the program 110 in accordance with the context and user-specific preferences. The second report presentation is textual in nature and includes a brief descriptive text which the program 110 maps to the finding in question. This brief descriptive text serves as the initial template, or “place holder”, which is subsequently expanded upon by the interpreting radiologist prior to report completion.

As an example, in the course of navigating through the imaging dataset, the radiologist may come across an abnormality in the right kidney (e.g., mass), which he/she wants to include in the report. The radiologist may bookmark the image by issuing an input command (e.g., mouse click), which records the exact location in the imaging dataset which is to be integrated into the report. At the same time, the radiologist may incorporate textual data to be linked to the imaging data finding using, for example, speech input and voice recognition software. In this example, the radiologist may input abbreviated textual data (e.g., right kidney mass) followed by the input command “incomplete”. This combined imaging and textual data is recorded by the program 110 into the report, with an “incomplete” status, thereby forcing the radiologist to input additional data for conversion to “complete” the status. After bookmarking all of the individual “positive” and “negative” findings in the report, the radiologist is prompted or alerted by the program 110 as to which findings remain in “incomplete” status, and must be finalized before the exam can be completed and signed off (i.e., approved). In doing so, each of the individual “incomplete” findings is sequentially presented to the radiologist for completion, by the program 110. In the example of the right kidney mass, the radiologist is tasked with incorporating additional data (e.g., size, morphology, differential diagnosis), which he/she deems necessary for report completion. If the radiologist attempted to sign (i.e., finalize) the report with individual findings in “incomplete” status, the program 110 would alert him/her as to the specific findings in “incomplete’ status and force the radiologist to convert each of these findings to “complete” status before the report can be finalized.

Another feature provided by the program 110 is to incorporate external data requirements in the reporting (see FIG. 2, step 202). These external data requirements can be derived from a number of sources, including the referring physician, community-based standards, or institutional requirements. In the example of the kidney mass, any of these external sources can trigger the program 110 to ensure that the radiology report data contains specific data elements in association with this particular finding (i.e., clinical significance, follow-up recommendations). These external data requirements could be presented by the program 110 to the radiologist at the time the individual finding is bookmarked, thereby providing the radiologist with the opportunity to incorporate the requested data prior to report completion. The program 110 would track the degree to which the requested data is successfully integrated into the reports, thereby providing an objective method for determining data completeness and compliance with community or institutional standards.

The data reconciliation processes which can be performed by the program 110 can serve to reconcile data within a single medical document (i.e., intra-report reconciliation), or data contained within separate and distinct medical documents or repositories (i.e., inter-report reconciliation) (see FIG. 2, step 203). An example of intra-report reconciliation would be the analysis of data consistency by the program 110. As an example, in a physician consultation note, there should be consistency as to the descriptive data assigned to a specific finding or observation. If, for example, a finding is described (e.g., right foot ulcer), it should be consistently stated as being “right sided” throughout the report contents. In conventional practice, it is not unusual for a finding to be described as “right” in one area of the report and “left” in another area. The program 110 of the present invention would ensure that the data within a single report or data repository is consistent, and if an inconsistency is documented, the program 110 would recognize the inconsistency and alert the author of the data and request formal reconciliation (see FIG. 2, step 205). Existing technology, such as natural language processing (NLP) is readily available to assist in performing this task, but would serve as a facilitation tool to notify the user of the discrepancy, but require formal reconciliation by a credentialed third party whose identity would be recorded by the program 110 in the database 113, 114.

One common example in radiology is when a medical imaging study is presented to a radiologist for interpretation, where discrepant data is recorded as to, for example, laterality. The clinical indication for an ankle radiograph may state “pain lateral right ankle following trauma”, but the images submitted for interpretation are labeled “left ankle”. The reconciliation of this data discrepancy can be clarified by either the technologist performing the imaging exam acquisition or radiologist interoperating the images. In either case, the invention would provide an alert as to the data inconsistency and provide a prompt for reconciliation. The party who reconciles the data would be required to modify the data (e.g. change clinical indication to state “pain lateral left ankle following trauma”), and the identity, date/time, and modification of the data recorded by the program 110 in the reconciliation database 113, 114 for future review and/or analysis.

Another straightforward example of intra-report reconciliation would be where the same finding is described as “3 cm liver mass” in one paragraph of a report (e.g. physician consultation report) and “3 mm liver mass” in another paragraph. The reconciliation tool of the present program 110 would notify the authoring physician by at least one of a variety of communication methods (i.e., electronic means such as email, text, facsimile, etc.), of the data discrepancy and request formal reconciliation. The date and time of the reconciliation recognition and notification would be recorded by the program 110 in the database 113, 114 to ensure that the data was identified, and the appropriate party notified and provided with the requisite information. If for any reason, the data reconciliation is not finalized within the corresponding database 113, 114 (e.g., EMR), the program 110 will flag it as “un-reconciled data”, and a quality assurance alert will be sent by the program 110 to the designated party (i.e., quality assurance specialist, department head, administrator) by a communication method, for review and further action.

This same example can be used to show how inter-report data reconciliation can be performed on a single finding, procedure, or observation, by the program 110. If, for example, a patient is scheduled to undergo a procedure (e.g., left extremity amputation), the data reconciliation tool of the present program 110 would review the data from corresponding reports (e.g., physician consultation note and procedure note) to ensure the corresponding data is consistent. If, for example, the consultation note states “left extremity amputation” is recommended, and the procedure note states “right extremity amputation performed”, the inter-report discrepancy would prompt formal review and amendment of the data. The date/time, data alteration, and party performing the data modification would be recorded by the program 110 in the reconciliation database 113, 114. The reconciliation tool of the program 110 mandates that any alteration in medical data (after initial documentation) is recorded in the database 113, 114 to ensure reliability and consistency or the medical data. If, for example, a physician was to change the data within a medical document (e.g., progress note) after it has been submitted, the reconciliation tool of the program 110 would record all changes made in the database 113, 114, and subject the data to further review to ensure data integrity, and alert users as to possible data tampering. This illustrates how the data reconciliation tool of the present invention can be used for quality assurance and identification of possible data tampering.

The data reconciliation tool of the program 110 of the present invention can literally track data which is stored, between any two data sources within the healthcare continuum. In radiology, for example, there is a stepwise progression in the “imaging cycle” which includes the following steps: exam ordering, scheduling, protocoling, historical data retrieval, acquisition, image processing, quality assurance, transmission, presentation, interpretation, reporting, and communication. Data from any of these data sources can be analyzed by the reconciliation tool of the program 110 to ensure consistency and analyze accuracy. As an example, data reconciliation analysis can be performed by the program 110 in the steps of exam ordering (CPOE database 113, 114) and protocoling (modality database 113, 114). If a physician orders a contrast enhanced CT of the brain to evaluate stroke, but the CT technologist performs a CT of the brain without contrast, the reconciliation tool of the program 110 would identify the discrepancy between the exam ordering and protocoling data, which requires formal clarification. In this example, a number of causative factors could have accounted for this data discrepancy including (but not limited to) patient allergy to intravenous contrast, inability to obtain intravenous access, or technologist oversight. In order to avoid unnecessary radiation, time delays, or repeat examination; the reconciliation tool of the program 110 could be integrated into the CT technology and set up to require formal data reconciliation before the acquisition step. This would illustrate how the reconciliation tool could reconcile data performed at different steps and using different databases 113, 114, to impact healthcare delivery at the point of care, for the combined purposes of improving timeliness, quality, and patient safety.

In addition to ensuring that all observed findings are captured in the report, a number of other features are included in the present invention. One feature of the program 110 is the “reconciliation” feature, which is the ability to automatically record in the database 113, 114, prior imaging report findings onto the current report (with the corresponding linked images). This provides an easy-to-use and efficient mechanism to promote direct comparison of historical and current report data. In the previous workflow models, in order to review historical report data, the end-user would be required to open up a separate report document and manually read the report, which includes a conglomerate of findings, which are most commonly presented in prose format (i.e., paragraph text). In contrast, with the present invention, the historical reports findings are automatically transposed by the program 110 onto the current working report document (see FIG. 2, step 201), thereby allowing the end-user to quickly and efficiently review prior report findings (and corresponding imaging/clinical data), while simultaneously providing a template from which the new report can be created with direct incorporation of historical and current data. In using such a system, temporal change of all historical findings would be accounted for, leaving little doubt in the minds of the persons reading the report as to what changes have transpired over time. While the radiologist would have the option of editing the transposed report findings, the present invention encourages the user to be as thorough and complete in reporting interval change and the associated clinical significance, which is commonly lacking in conventional reporting.

The transposition process (of historical report findings) can be customized to the specific needs and preferences of each individual end-user, by the program 110. These customization features presented by the program 110 to the user, can determine which report findings are transposed, how they are presented, and the specific types of data content which are included.

In many circumstances, a patient's imaging folder will contain multiple historical imaging reports, which could have potential relevance to the current imaging study being performed. As a result, computerized (i.e., automated) extraction of historical report findings (i.e., by the program 110) would require a rules-derived mechanism (using neural networks) for determining relevance. The various factors included in this analysis by the program 110, would include the following: 1) anatomic region, 2) clinical indication, 3) imaging modality, 4) chronology, and 5) findings. An end-user may establish individual search criteria specific to the imaging modality and clinical indication, which can be rapidly expanded or minimized by the program 110 at the point of image review.

As an example, a patient who has known lung cancer and has undergone multiple sequential chest CT exams to evaluate treatment response may now have a chest radiograph ordered to assess central venous catheter placement. Based upon this clinical indication, the radiologist is focused on providing report data which determines the catheter placement and potential complications relating to the procedure. Details regarding the lung cancer are not necessarily important in this report, due to the imaging modality employed (radiography) and recent CT report, which in detail described tumor-related findings. As a result, the radiologist may opt to minimize (or even cancel) the number of transposed historical report findings. One simple and easy-to-use option would be to have the user have the program 110 limit the transposition process to the most recent chest radiographic report.

If, on the other hand, the same radiologist was tasked with interpretation of a chest CT exam on this patient for the clinical indication of “re-evaluate lung cancer following completion of radiation therapy”, the historical data requirements would be far more complex. In this situation, the radiologist may opt to use the program 110 to automatically transpose report findings form the most recent reports of all imaging modalities (e.g., CT, MRI, and PET).

In addition to automated historical data extraction by the program 110, the radiologist can opt to manually extract historical data. This could include manually selecting the individual studies of interest (e.g. chest CT Dec. 10, 2009) or the specific findings of interest.

Thus, as noted above, one feature of the present invention is that the program 110 automatically extracts historical report data from the patient's imaging folder (with corresponding imaging data), and transposes this data onto the current report for correlation. The determination of which imaging data is relevant is a customizable feature, which is both context and user-specific, with the ability to manually edit at the point of operation. The goal is to encourage comprehensive reporting which takes into account all historical and current findings of relevance and document interval change and clinical significance on a finding-specific basis.

One method for “targeted” extraction of historical data by the program 110, would be to direct historical data extraction in real-time, as individual findings from the current report are being created by the user. This would reduce the amount of extraneous (and clinically non-relevant) data for the user to review, and provide the individual with only the specific data of interest to the task at hand. In the example of the radiologist interpreting the chest CT for re-evaluation of lung cancer, the radiologist can elect the program 110 to initiate historical data extraction based upon contemporary findings only (as opposed to automated extraction of “all” historical data specific to the anatomic region, clinical indication, and imaging modality in question). As the radiologist bookmarks individual findings on the current study, he/she may input a command which determines which findings require historical data extraction and which do not. This command can be instituted in a variety of ways including (but not limited to) a specific keyboard function, icon on the user interface, button on a multi-programmable mouse, or speech command (e.g., “search data”), for example. Each individual end-user can prescribe specific search criteria and rules to the program 110 for the historical data search (e.g., time constraints), to further refine the historical data extraction process.

When different data sources are available for historical data extraction (e.g., multiple PACS or EMR systems within a multi-institutional healthcare network), it becomes more challenging to prioritize data extraction. The ability of the program 110 to direct historical data extraction specific to individual findings and data sources creates a more effective means of ensuring that all relevant data is reviewed, analyzed, and integrated into the current reporting process.

While the examples presented primarily focus on the application of the invention to medical imaging, it can certainly be applied to all other medical disciplines. One can easily see how the ability to automate the extraction of historical data specific to individual data elements (e.g., disease, procedure, symptom) can dramatically improve both the quality and timeliness of data extraction and analysis.

One example would be in the review of pharmacologic treatment of a specific disease (e.g., diabetes) in a chronic diabetic who has been treated at multiple institutions. A physician could direct the historical data extraction feature of the program 110 to be specific to the data of interest (i.e., diabetes and pharmaceuticals), and for the program 110 to present the user with an historical presentation of different drug therapies, treatment response, and complications. This could prove beneficial in guiding future pharmaceutical decisions.

As an example, if one class of diabetic medications was associated with improved compliance (e.g., daily dosage) and improved clinical response (e.g., linked daily glucose measures), that would provide insight as to preferred treatment regimens in the future specific to the individual patient. A great deal of this historical data would otherwise be overlooked, given the fact that conventional data extraction is largely manual, restricted to a single database, and does not include ‘linked” multi-disciplinary data elements.

Another important reconciliation feature of the program 110 of the present invention is related to the “clinical indication”, which is the reason the imaging study has been requested by the user. In conventional practice, all ordered medical studies must have a clinical indication for justification. The quality and quantity of data provided in the “clinical indication” has been a chronic point of contention for imaging providers. In many circumstances, the ordering clinician provides minimal (or even erroneous) clinical information, which has a detrimental impact on the radiologist's ability to render a complete and accurate interpretation. While computerized physician order entry (CPOE) systems have attempted to address this deficiency, the problem persists, due to the ability of ordering physicians to “game” the system. A referring physician (or staff) quickly learns what is the minimal information required to successfully order a given imaging study and uses this as a short cut to minimize the input effort required. This has the adverse effect of providing little or no guidance to the interpreting radiologist, and may lead to erroneous or ambiguous report data (i.e., garbage in, garbage out).

One feature of the present invention is where the program 110 automatically transposes the clinical data provided by the ordering physician and integrates this into the imaging report. The interpreting radiologist in turn, must directly address the all important clinical question as to whether the imaging data answers the clinical question being posed, and does so by identifying the specific report findings of relevance. A number of standardized reporting options are created by the program 110 which answer this clinical question; which in turn, can go into a report database 113, 114 for longitudinal analysis by the program 110. The various analyses which can be derived by the program 110 from this “clinical indication analysis” include appropriateness, cost-efficacy, and meaningful use, while also providing critical data for establishing best practice (i.e., evidence-based medicine) guidelines.

An example of how this “clinical indication” data is transposed, reported, and analyzed by the program 110 is as provided. An abdominal CT exam is ordered on a 35 year old female patient who is evaluated for acute abdominal pain, which is localized to the right lower quadrant, and accompanied by nausea, vomiting, and a fever of 101 degrees Fahrenheit. The patient's prior medical history is significant for previous cholecystitis, resulting in cholecystectomy (i.e., gall bladder removal).

For this representative example, three different clinical indications are provided by the ordering physician: 1) abdominal pain, 2) right lower quadrant abdominal pain, and 3) acute right lower quadrant abdominal pain with fever, prior surgical history cholecystectomy.

The following imaging report findings are recorded by the interpreting radiologist: 1) fatty infiltration of liver, 2) left renal calculus, 3 mm, non-obstructing, 3) bowel dilatation, ileus, 4) free fluid, right lower quadrant, and 5) sigmoid diverticulosis.

The only prior abdominal imaging study of record is a prior right upper quadrant ultrasound, which diagnosed gallstones and acute cholecystitis, resulting in the cholecystectomy. Fatty infiltration of the liver was noted on the prior report, so that represents a stable finding.

The clinical indication reporting feature of the program 110 of the present invention requires the radiologist to report on whether the imaging report data does or does not address the clinical indication data provided, with the following options:

1) Yes (clinical indication is accounted for, based upon the following report findings).

2) No (report findings listed do not account for the clinical indication provided).

3) Maybe (report findings are somewhat equivocal relative to the clinical indication provided; the report findings of interest include the following).

4) Uncertain (the clinical indication data presented is insufficient in determining correlation with the report findings).

Based upon the three (3) different clinical indications presented in the example and the imaging report findings, the clinical indication reporting feature of the program 110 of the present invention would likely result in three different conclusions:

1) Abdominal pain—Uncertain (the clinical indication data presented is insufficient in determining correlation with the report findings). Left renal calculus, 3 mm, non-obstructing; Bowel dilatation, ileus; Free fluid, right lower quadrant. Sigmoid diverticulosis.

In another words, the radiologist has identified four (4) positive findings on the imaging exam, any one of which could conceivably be the source of abdominal pain. Without additional clinical data, further specificity as to which of these findings is the source of the patient's symptoms cannot be reliably ascertained.

2) Right lower quadrant abdominal pain—Maybe. Report findings are somewhat equivocal relative to the clinical indication provided; the report findings of interest include the following: Bowel dilatation, ileus; Free fluid, right lower quadrant;

3) Acute right lower quadrant abdominal pain with fever, prior surgical history cholecystectomy—Yes (clinical indication is accounted for, based upon the following report findings); Bowel dilatation, ileus; Free fluid, right lower quadrant.

In this example, the added specificity of abdominal pain location has effectively eliminated the findings of left renal calculus and sigmoid diverticulosis as the underlying cause, since both of these findings occur in anatomic regions which would not be expected to produce right lower abdominal pain.

When correlating the clinical and imaging findings using the program 110, the presumptive diagnosis is appendicitis. This diagnosis is arrived at by combining the clinical and imaging data available.

The following features of the program 110 are illustrated in this example:

1) The clinical indication feature of the program 110 addresses an important report component which is currently lacking; namely, the requirement to determine whether report findings account for the clinical indication of record.

2) The reporting reconciliation feature of the program 110 requires the radiologist to state which specific report findings account for the clinical indication (i.e., of direct relevance).

3) The report database 113, 114 derived from the program 110 clinical indication feature provides a number of analyses, which ultimately are aimed at improving clinical outcomes.

4) The clinical indication data can also be used for educational and training purposes by the program 110, for radiologists, technologists, and ordering clinicians. This feature of the program 110 provides longitudinal data for each ordering physician, as to the completeness of clinical data presented and the appropriateness of exam ordering. The interpreting radiologist can gain valuable insight as to whether they are providing accurate and confident diagnostic report data relative to their peers, as well as specific areas of deficiency for remedial educational efforts.

Another reconciliation feature of the program 110 of the present invention is the ability to extract and transpose clinical data (as opposed to imaging data) into the imaging report. Clinical data can be numerical (e.g., laboratory study), textual (e.g., hospital discharge summary), photographic (e.g., pathology), or graphical (e.g., temperature time-activity curve, serial plot of white blood cell count). With this feature, the program 110 combines clinical and imaging data into a single comprehensive report to illustrate the association relationships between clinical and imaging data, which in turn can be used to arrive at a specific diagnosis or disease. Over time, the knowledge gained by analyzing these clinical and imaging data relationships in determining clinical diagnoses and “best practice” guidelines can be used to create computerized decision support tools. In this particular example, if the radiologist interpreting the abdominal CT scan for the clinical indication of right lower quadrant pain and fever reported the positive findings of bowel dilatation and free fluid; the program 110 could search its database 113, 114 (of imaging, clinical, and association data) to determine the statistical probability of different disease states. In doing so, the derived analysis by the program 110 could yield a list of potential differential diagnoses along with associated statistical probabilities. The radiologist could in turn utilize this computer-derived decision support data in report creation.

Thus, in the present invention, the reconciliation tool of the program 110 records, tracks, and analyzes radiology report data on an individual finding-specific basis. As each individual radiology report finding is recorded in the database 113, 114 by the program 110, it would, for example, have an assigned extensible markup language (XML) tag, which would be tracked longitudinally over the lifetime of the specific disease process by the program 110. This XML tag would applied to all associated data, including imaging (pixel), laboratory (numerical), and pathology (textual). Using a mammography example, if a report described suspicious micro-calcifications with recommendation for biopsy (BI-RADS 4), the associated XML tag would be linked by the program 110 with associated imaging and clinical data including pixel data (of current, prior, and future imaging studies), genetic data, surgical consultation data, procedural report data (e.g., biopsy) and pathology report data. The advantage of this approach is that all individual findings are separately catalogued and analyzed.

In the common example of the mammogram with multiple findings of “calcifications”, each individual finding would be referenced individually by the program 110, so that report/clinical data reconciliation by the program 110 could be done individually and not collectively, as is the current practice using BI-RADS. By creating a finding-specific XML tag, all “downstream” data becomes directly linked by the program 110 to the finding and can be searched and longitudinally analyzed, regardless of where the individual data is stored. In the case of the suspicious micro-calcifications on the mammogram report, a pathologist interpreting the biopsy specimen could directly access all longitudinal imaging and clinical data linked to this finding, in the database 113, 114. In addition to providing a direct link of the pathology report textual and imaging data to this XML tag, the pathologist may also have the opportunity to incorporate additional data (e.g., proteomic data) in the EPR not previously recorded in the database 113, 114. As new imaging data is recorded by the program 110 (e.g., post-procedural mammogram), this also becomes linked to the original finding, thereby allowing a healthcare provider to chronologically review the entire imaging and clinical history of a specific finding in a single search. Once standards are created providing a uniform mechanism for cataloging and storing this data, multi-institutional finding-specific data can be linked, so that an individual patient seeking medical care at multiple facilities would have a single, combined database; which can be searched based upon individual findings or disease processes.

Some of the workflow strategies to improve productivity using structured reporting are disclosed in U.S. patent application Ser. No. 11/586,580, filed Oct. 26, 2006, the contents of which are herein incorporated by reference, and include auto-population of historical report findings, creation of context and user-specific structured reporting macros, and use of standardized graphical mark-up and annotation of imaging data. Since a large number of report findings are repetitive on sequential imaging exams, time savings can potentially be realized by simply editing “auto-populated” prior report data onto the current radiology report.

One of the most important clinical attributes of BI-RADS is its ability to standardize the clinical significance and follow-up recommendations of the collective report findings, which serves as a clear and unambiguous guide to clinical management. By the program 110 creating a standardized reporting mechanism for quantifying clinical significance, follow-up recommendations, and temporal change; each individual finding can in essence have the equivalent of its own BI-RADS score. This would not only serve to guide clinical management on a finding-specific basis, but also serve as a direct mechanism in which clinical outcomes data can be retrospectively linked by the program 110 to each individual report finding.

As an example, a mammogram contains 4 report findings:

1. Macro-Calcifications

9 o'clock right breast

Low clinical significance

No temporal change

No follow-up required

2. Nodule

3 o'clock left breast

7 mm

New

Uncertain clinical significance

Ultrasound correlation recommended

3. Micro-Calcifications

10 o'clock left breast

Pleomorphic

Increased in number

High clinical significance

Biopsy recommended

4. Micro-Calcifications

6 o'clock left breast

Punctate

No temporal change

Low clinical significance

No follow-up required

Each of the four individual findings would have its own unique XML tag applied by the program 110, which would be linked with corresponding finding-specific imaging and clinical data from previous (and future) imaging reports and clinical data. In the case of the 7 mm left breast nodule, the follow-up ultrasound report and imaging data would be linked to that finding alone, by the program 110. In the case of the suspicious micro-calcifications at the 10 o'clock position left breast, all subsequent clinical data related to the recommended biopsy would be linked by the program 110. This data would not be linked to the second group of micro-calcifications at the 6 o'clock position. Longitudinal analysis of the mammogram report data would be individualized for each specific finding, by the program 110, taking into account future mammogram report findings (to assess interval stability), peer review (of both radiologists and clinicians), along with clinical outcomes data. A healthcare provider searching the database 113, 114 could generate a query for “micro-calcifications” and be presented by the program 110 with each separate finding of micro-calcifications recorded over the lifetime of the patient, all linked imaging and clinical data, and finding-specific report/clinical data reconciliation. At the same time, a radiologist who has participated in that patient's medical imaging record can generate a query specific to his/her report data and receive finding-specific data reconciliation analyses by the program 110, along with all linked imaging and clinical data linked to each specific finding of interest. In this manner, the data reconciliation tool of the program 110 provides a searchable mechanism for finding and user-specific queries, which can be used for education and feedback.

Once the report data has been standardized and entered into a referenceable database 113, 114 by the program 110, the program 110 records finding-specific clinical data, which is important to the process of data reconciliation. The identification of finding-specific clinical outcome data could be derived through both manual and computer program 110 methods. In the manual method, a physician (e.g., referring clinician or consultant) could provide clinical feedback at any time during the clinical management of the patient. This could occur at the time the radiology report is first reviewed, as new clinical data is received, or at the time of discharge from service. Vital sources of clinical outcomes data would include discharge summaries, consultation reports, and history and physicals. During the course of the discharge summary report creation, the referring clinician may be prompted by the program 110 to link all relevant imaging data regarding clinical diagnosis, management, and treatment. In the course of doing so, he/she would link specific clinical data (e.g., laboratory data, clinical tests, pharmacology) to the XML tag of individual imaging report data, along with supplemental information regarding the diagnostic accuracy of the report data. The clinical feedback provided could be recorded in the database 113, 114 by the program 110 in a standardized fashion identifying the data source, confidence in establishing diagnosis, and degree of radiology report/clinical outcome data reconciliation.

The subsequent data would be recorded by the program 110 into the finding-specific database 113, 114 and all clinical data sources (over time) would be pooled for final data reconciliation. As the clinical data is recorded, automated prompts would be provided by the program 110 to the radiologists of record, which can be used to instantaneously review the finding-specific data of interest. Each individual end-user can create their own customized profiles in the database 113, 114 which would identify preferences for data presentation and analysis. The large number of reports and individual findings would provide large sample size statistics, which would accumulate over time, and be available for reference peer analytics, using the program 110.

In addition to human input of clinical data, computerized agents in the program 110 can be used to automate clinical (and imaging) data extraction. The simplistic example of the patient with suspicious micro-calcifications recommended for biopsy would generate an automated prompt by the program 110 to record all surgical and pathology data and directly link that data to the specific finding of micro-calcifications. The standardized pathology and imaging report data could then be correlated by the program 110 to determine the extent of agreement, which would then be used for computer generated (program 110) data reconciliation. As the database 113, 114 matures and automated search technologies become better integrated into the technology, computerized data reconciliation can begin to be performed by the program 110 by cross-referencing the standardized radiology report and clinical outcomes data. This would have the desired effect of automating longitudinal analysis, maximizing the amount of relevant data incorporated into the analysis, and reducing the impact of human bias and error. The combined human and computer analytics would be iterative in nature, so that cumulative knowledge, experience, and automated search techniques would be refined over time; with the hopes of improving the accuracy and completeness of the derived analytics.

In another example, the imaging findings on a chest radiographic report may include: 1) Cardiomegaly; 2) Airspace disease, right lower lobe; and 3) Degenerative changes, thoracic spine.

A search of the patient's clinical data (found within the EMR), by the program 110, identifies these findings: 1) Productive cough (History); 2) Fever (Physical exam); and 3) Leukocytosis (Laboratory data).

The radiologist renders a diagnosis of pneumonia, based upon the imaging finding of right lower lobe airspace disease, combined with the clinical data of productive cough, fever, and leukocytosis. The ability of the program 110 to directly integrate the clinical and imaging data into a single report provides a mechanism for improving the confidence and specificity of diagnosis.

Thus, the reconciliation tool for reporting includes: reconciliation of observed and reported contemporaneous imaging data; reconciliation of historical and current imaging data; and reconciliation of clinical and imaging data.

The derived functionality from the report data reconciliation includes:

1. Automated reporting workflow.

2. Direct registration of finding-specific image/report data.

3. Creation of a finding-specific association database (i.e. association relationships between clinical and imaging data).

4. Extraction of historical imaging data.

5. Context and user-specific report customization.

6. Customizable finding-specific communication/consultation.

A number of computerized decision support technologies are currently in use for automated extraction of clinical data from the EMR, and the program 110 may include these known decision support technologies to integrate the extracted data into the radiology report for the purposes described above.

Another component of the present invention is the Communication Tool. The first feature of the Communication Tool of the program 110 is the multi-user input function, which provides the ability of multiple individual end-users to import data into the report. Using a radiology report as an example, several functions and stakeholders are active in the multi-step process of a medical imaging study apart from the interpretation and creation of a final report. These include exam ordering (clinician), patient consultation (technologist/radiologist), contrast administration (nurse), protocol selection (supervisory technologist), image acquisition (technologist), image processing (technologist) and quality assurance (QA specialist). Each individual step has the potential to capture and record data specific to the function being performed and have that data incorporated into the final report.

As previously discussed in the reconciliation tool of the program 110, the clinical indication is automatically transposed by the program 110 onto the report, and requires reconciliation by the user, as to whether the report findings answer the clinical question being posed. In addition to the clinical indication, additional clinical and/or historical data may be of relevance, which may not be contained in the abbreviated clinical indication data.

As an example, an oncology patient may have a complicated prior treatment history, including multiple surgeries, chemotherapy, and radiation therapy. While this data would not be expected to be incorporated into the clinical indication data (e.g., follow-up lung cancer), it may be important to the interpretation and reporting of the imaging data, and therefore, be relevant to the report. The communication tool of the program 110 provides a mechanism in which another end-user (e.g., referring clinician) may supply supporting data, which can be directly or indirectly incorporated into the report. A direct integration may include embedding this supporting data directly into the report using the program 110, while indirect incorporation may include the program 110 providing an external link to the data, which can be accessed (e.g., through a hypertext link) by the user activating a key word or words in the report.

An example of how these direct and indirect multi-user communication tool functions of the program 110 can be used, is illustrated in two versions of a chest CT report for a lung cancer patient.

Direct Link: Paramediastinal stranding right upper lobe; consistent with prior history of right upper lobe surgical resection (1999) and radiation therapy (2000).

Indirect Link Post-surgical and radiation scarring right upper lobe.

Activation of link provides this data: Prior history of right upper lobe resection 1999; Prior history of radiation therapy, 3 treatments, completed 2000.

The manner in which this multi-user data input is incorporated by the program 110 into the final report, is at the individual discretion of the report author (e.g., radiologist), who can choose what imaging/report data is utilized and how the data is presented.

Other examples of multi-user report data input could include:

1) Data obtained through patient consultation (e.g., past medical history, pharmaceuticals, disease problem list).

2) Data attributable to contrast administration (e.g., type, mode of delivery, volume, adverse actions).

3) Data related to image acquisition and processing (e.g., radiation dose, specialized processing techniques, technology utilized).

4) Quality related data (e.g., patient compliance, artifacts, quality deficiencies).

Due to the fact that most of this data is not obtained or directly accessible to the radiologist during image interpretation, external input from a knowledgeable third party (e.g., technologist) is required to be included in the final report. At the same time, it is important for the program 110 to document the source of this data, in order to ensure integrity and reliability of the data source. In the course of an adverse clinical outcome (e.g., allergic reaction to intravenous contrast, motion artifact limiting exam quality), it is important for the program 110 to document relevant data in the final report (and associated report database 113, 114) and use this data for effective intervention. As an example, a technologist who has multiple quality assurance (QA) deficiencies of a similar nature and exam type would not customarily have this data recorded in the report or tracked in the report database 113, 114. Having the capability of the program 110 consistently recording this data into the report (by the QA specialist) and corresponding database 113, 114 would provide an effective means to identify the problem source and the ability to intervene through remedial education/training.

In addition to multi-user data input, another function of the communication tool of the program 110 is the ability to initiate consultation and communication relative to imaging/report data (see FIG. 2, step 206). In conventional reporting practice, communication and/or consultation regarding report data is manual in nature. A clinician who has a question or concern regarding a report would have to contact the radiologist directly in order to have their particular concern addressed. The concern may include a missed finding, erroneous diagnosis, or additional clinical information—all of which could affect the accuracy of the report. In the event that the radiologist decided to amend the report as a result of this consultation, he/she would issue an addendum, which would typically include a few sentences attached to, but separate from the original report. Due to the fact that this addendum is chronologically separate from the original report, other clinical parties reviewing the report may not be aware of the changes made.

Using the communication tool of the program 110 of the present invention, any electronic consultation/communication which takes place during the lifetime of the report can be automatically recorded, tracked, and analyzed by the program 110. A referring clinician who wants to alert the radiologist of additional clinical data which may affect the report findings and conclusions may do so, by using the Report Consultation tool of the program 110. The sequence of events would appear as follows:

1) Clinician opens report in computer system (the clinician's identity can be established through Biometrics or their unique sign on).

2) Clinician activates specific finding in report or imaging dataset of interest.

3) Clinician inputs data (through speech or manual text input) of concern.

4) The input data is recorded by the program 110 in the report database 113, 114, along with registration of the end-user supplying the data, the data being recorded, and the related report/imaging finding.

5) The entry data is automatically transmitted to the radiologist authoring the report using electronic methods, for example, by the program 110, with electronic confirmation receipt required. (The program 110 records the date, time, and identity of the individual receiving the data in the database 113, 114).

6) The radiologist has the option of modifying the report (based upon the data being presented), maintaining the report “as is”, or providing a targeted response to the inquiry.

7) Any modifications made are recorded by the program 110 in the report database 113, 114 (and time stamped), along with highlighted changes to the final report.

8) The program 110 identifies all individuals who have reviewed that specific report to date, along with designated clinical care providers of record for that patient.

9) An electronic alert is automatically sent by the program 110 to those individuals, notifying them of the report modifications and/or additional report data being recorded by the program 110.

10) Any of these end-users can open up the link being presented by the program 110 and be provided with highlighted areas by the program 110 of new and/or modified report data, along with the “old” and “new” versions of the report.

11) The end-user has the option to respond to the report data changes, if desired.

12) A report review acknowledgement is recorded in the report database 113, 114 by the program 110, documenting the receipt and review of the modified report data by the individual, along with any questions or comments entered during the review process.

Using the same technology, the program 110 communication tool can also be used for critical results communication. In this scenario, the specific finding(s) of high clinical concern is electronically transmitted by the program 110 to the responsible clinical party/parties, with electronic documentation of receipt. Any ensuing communication between the parties (i.e., sender and recipient) is recorded in the report database 113, 114 by the program 110, along with subsequent clinical actions.

The representative sequence of events in this Electronic Critical Results Communication schema is as follows:

1) Radiologist creates report in computer system and identifies specific finding(s) of critical concern.

2) Radiologist initiates the program 110 Critical Results Communication pathway.

3) The report and imaging findings of concern are electronically transmitted by the program 110 to the referring clinician.

4) Referring clinician receives emergent notification of critical results by the program using an electronic communication method.

5) Referring clinician opens up the attachment of the critical report/imaging data of the electronic emergent notification, with data, including specific findings, clinical recommendations, and emergent status. The action provides an electronic notification of receipt which is recorded by the program 110 in the database 113, 114.

6) Any electronic communication between the referring clinician and reporting radiologist are captured by the program 110 in the report database 113, 114.

7) The program 110 tracks ensuing clinical actions and orders in response to the critical results being communicated (e.g., physician orders, consultations, follow-up imaging studies).

8) The program 110 creates an electronic link (with time stamps and end-user identification) between critical report findings, subsequent orders, and resultant data.

9) When the report is reviewed at a later date by the user, the critical findings of record are electronically linked by the program 110 to the longitudinal record of resulting clinical actions.

Another feature of the communication tool of the program 110 is the ability to link clinical data to individual report findings, without creating a formal consultation. In this situation, a referring clinician may wish to incorporate clinical data into the report, to assist them in their own clinical management and decision-making.

As an example, a family practitioner (Dr. Jones) reviews a chest radiograph report on a patient with a 10 mm lung nodule. The physician determines that additional clinical data may be relevant including the patient's smoking history and genetic disposition to lung cancer. The physician uses the program 110 to link this clinical data to the report finding (lung nodule) and requests a pulmonary consultation for further evaluation.

Whenever Dr. Jones was to review the report, the additional clinical data input (smoking history and genetic predisposition) is linked to the radiologist report finding by the program 110, along with the order for pulmonary consultation. Once Dr. Jones has linked this additional clinical data into his personal copy of the radiology report, an electronic notification is sent by the program 110 to the radiologist of record, alerting them to the additional data input. The radiologist is then provided by the program 110 with the option of formally linking (or not linking) the clinical data presented by Dr. Jones into the final radiology report.

The third component of the program 110 of the present invention is the Education Tool. While the invention is primarily centered on the reconciliation tool, with its three data reconciliation functions, the derived data is subsequently used by the program 110 to create the Communication and Education Tools. At the core of the Education Tool is a Referenceable Reporting database 113, 114, which collectively is used by the program 110 to record and store data. The program 110 tracks and analyzes the various data created by the Reconciliation and Communication Tools. The combined clinical and imaging data are primarily sorted by the program 110 according to the individual findings they are attached to, while secondarily sorted by the program 110 in accordance with the individual end-user profile (see FIG. 2, step 204). This end-user profile is a system created by the program 110 to classify individual end-users according to occupational status, practice type, institutional characteristics, and individual characteristics. The ability of the program 110 to analyze how clinical and imaging data is entered, accessed, and used by individual end-users in the performance of their everyday activities provides insight and predictability as to their individual future data requirements, in accordance with the context of the data and task being performed. (This type of individual end-user data tracking behavior can be performed using electronic auditing tools, which are currently available and in use for automating workflow in accordance with context and end-user characteristics (see pending U.S. patent application Ser. No. 11/586,580, filed Oct. 26, 2006, the contents of which are herein incorporated by reference in their entirety).

End-User Profile Characteristics Include:

1. Occupational status

2. Practice type

3. Institutional characteristics
a. Size
b. Geographic location
c. Academic status
d. Patient population served
e. Technology in use

4. Individual characteristics
a. Age
b. Gender
c. Education and training
d. Computer proclivity
e. Personality
f. Stress

An example of how the individual end-user profile of the program 110 plays an important role in the present invention, is illustrated as follows.

Three different radiologists are tasked with the interpretation of a chest CT exam for evaluation of a patient with documented lung cancer, who has undergone treatment. On the most recent CT report, the tumor has been shown to decrease in size by 50% volume following completion of chemotherapy and radiation treatment. The radiologists' profiles are as follows:

Dr. James (Rad A): Subspecialty trained, academic teaching hospital, technophile. Dr. Smith (Rad B): General radiologist, community hospital, technophile. Dr. Maxwell (Rad C): General radiologist, community hospital, technophobe.

Based upon the task being performed, clinical data, and historical imaging data, a number of data mining variables can be predicted by the program 110, in relation to each individual radiologist:

1) What specific types and numbers of historical imaging studies need to be reviewed?

2) What specific report findings are of interest?

3) What associated clinical data is relevant?

4) What decision support tools will be utilized during the course of interpretation?

5) What specific historical images will be reviewed?

The ability to predict the answers to these questions lies in the program 110 analysis of: prior imaging studies in this same patient (patient specificity), similar imaging studies (exam specificity), other patients with similar diagnoses (data specificity), and similar imaging studies reviewed by the individual radiologists being evaluated (user specificity).

The combined analyses by the program 110 reveal the following predictions:

1) All radiologists will want to review the most recent chest CT exam. In addition, Dr. James (Rad A) will also want to review the imaging studies (CT and MRI) at the time of initial diagnosis, along with the 2 most recent chest CT exams. Dr. Smith (Rad B) will also want to review the CT exam at the time of diagnosis, but not the corresponding MRI.

2) All three radiologists are interested in reviewing imaging data related to the principal finding (diagnosis) of lung cancer along with secondary findings of metastases. Drs. James (Rad A) and Smith (Rad B) will also want to review all findings on the most recent chest CT report; along with Dr. James' interest in reviewing all findings classified as “high or intermediate” clinical significance on the three (3) most recent imaging studies.

3) There is a wide disparity in the clinical data of interest between the three radiologists. Dr. James (Rad A) is interested in all longitudinal clinical data linked (i.e., associated with) the original diagnosis of lung cancer, which includes the original pathology report data, bronchoscopy report data, radiation oncology consultation data, and medical oncology consultation data. Dr. Smith (Rad B) is interested in reviewing the pathology report data, along with the original oncology consultation data. Dr. Maxwell (Rad C) is only interested in the pathology report diagnosis.

4) Decision support tools are used.

5) Historical images are reviewed.

In addition, the program 110 can determine what types of analytics are derived from the data and how are implement these for educational and training purposes. Analytics include:

1) Clinicians—quality and quantity of clinical data (including association data linkage), appropriateness of services requested, utilization efficiency (relative to comparative cost, timeliness, and clinical outcomes), follow-up of data being presented (i.e. clinical efficiency)

2) Radiologists—diagnostic accuracy and confidence, completeness in data reconciliation and documentation, utilization of clinical/imaging data available, communication/consultation efficiency.

3) Technologists—documentation of technical data, protocol optimization, patient safety.

4) Administrators—compliance of industry and institutional standards (e.g., critical results communication), professional staff education and training, identification and intervention of clinical outliers, technology support and maintenance.

5) Patients (and other consumers)—individual and institutional analysis of clinical outcomes analysis, cost-efficiency, and safety, individual compliance (patients), availability and sharing of relevant data.

Thus, the deliverables of the Referenceable Report Database include:
6) Education/training
7) Personalized feedback
8) Decision support
9) Automated data extraction (context and user-specific)
10) Longitudinal data integration and clinical analysis.
11) Research (e.g., clinical outcomes, utilization, cost-efficacy, technology development).

The goals and desired outcomes which are determined by the program 110 include:

1) Have the program 110 create objective accountability measures to ensure that data is being accurately recorded, analyzed, and utilized, in order to optimize clinical outcomes.

2) Have the program 110 utilize this data to create best practice guidelines (EBM).

3) Have the program 110 provide an automated mechanism for data delivery at the point of care, which can be customized in according with context and user-specific preferences.

4) Have the program 110 utilize the data to facilitate new technology development, aimed at decision support, timeliness, safety, and operational efficiency.

5) Have the program 110 create educational and training tools which can utilize the data to identify individual and institutional deficiencies and provide insights and recommendations on opportunities for improvement.

6) Have the program 110 create new technology (e.g., automated workflow tools) based upon end-user auditing tool data and performance analyses.

As noted above, radiology is used as the primary discipline for purposes of discussion, but all medical disciplines could utilize the present invention technology for data reconciliation.

Examples of other disciplines that could benefit from the present invention include:

1) Pharmaceutical decision making.

2) Ordering of clinical tests.

3) Physician consultation services.

4) Evaluation of response to ongoing treatment (e.g., chemotherapy in oncology patient).

5) Evaluation of clinical care providers within a given network (e.g., insurance).

In order to illustrate how the present invention is implemented, from the perspectives of the multiple different end-users, an illustrative example is provided which tracks the course of an imaging exam through the sequential steps of clinical presentation, ordering, performance, interpretation, communication, and institution of treatment.

In this example, a patient (Mrs. Levy) presents to the emergency room (ER) due to acute onset of shortness of breath and pleuritic chest pain. The emergency room physician (Dr. Quinn) briefly examines Mrs. Levy and questions whether the presenting symptoms are due to pneumonia or a pulmonary embolism (blood clot). He orders for a few laboratory studies along with a chest CT angiogram, in order to expedite diagnosis and treatment.

After the blood work has been drawn for the laboratory studies, the patient is transferred to the radiology department for the chest CT angiogram. Following completion of image acquisition, the images are submitted to the radiologist for interpretation. Once the report has been finalized, it is sent to Dr. Quinn in the emergency room, in order to initiate appropriate clinical treatment.

The sequence of steps, actions taken, and reporting deliverables are listed below; which illustrate the modified workflow following implementation of the present invention.

The present invention offers a number of improvements in workflow, data management, and clinical outcomes in comparison to the conventional model described.

A. Physician: Exam Ordering

1. Patient presents to ER for medical care.

2. Patient is evaluated by triage nurse, and the program 110 records the requisite clinical data inputted by the triage nurse, for disposition, in the database 113, 114.

3. Patient is evaluated by the ER physician, who examines the patient, reviews nurse's clinical notes presented by the program 110 in the EMR, and the available historical data from the database 113, 114.

4. Based upon the information available and presumptive diagnosis, the ER physician places orders; which may include an imaging study for diagnosis.

5. All data recorded by the physician (including orders) are incorporated by the program 110 into the “clinical data”, which accompanies the imaging exam order (for chest CT angiogram).

6. In this example, the clinical data “shortness of breath and chest pain” is accompanied by the following data which was taken from the ER physician assessment and orders and recorded in the database 113, 114 by the program 110:

a. Surgical history: CABG

b. Physician exam: respiratory rate 44, blood pressure 152/96, pulse 90

c. Medications: Plavix, OCP, Glucophage

d. Differential diagnosis: Myocardial infarction, Pulmonary embolism

e. Orders: cardiac enzymes, arterial blood gas, d-dimer, routine chemistry and CBC

B. Technologist: Exam Performance

1. Upon the program 110 notifying the appropriate parties of receipt of the imaging exam order, the clerical staff in the imaging department alerts the appropriate technologist of the exam to be performed.

2. The technologist reviews the order, and accesses clinical data presented by the program 110 in the patient EMR and imaging data in the PACS, referable to the clinical history and examination requested.

a. Renal status (BUN, creatinine, GFR).

b. Allergies

c. Medications.

d. Height and Weight

e. Medical problem list

f. Prior imaging studies and reports.

3. Technologist identifies several clinical/imaging data of importance:

a. Renal insufficiency

b. Cardiac

3. The patient arrives to the imaging department and is transported to the appropriate area.

4. The technologist interviews the patient, in order to obtain additional clinical and historical information which will be pertinent to the exam, and which is recorded by the program 110 in the database 113, 114.

5. The technologist reviews available imaging and/or clinical data in the patient's electronic medical records (EMRs), which are presented by the program 110.

6. Based upon the available information, the technologist selects the appropriate exam and protocol and enters this information in the database 113, 114.

7. The imaging examination is performed and the results stored in the PACS by the program 110, for radiologist review.

8. Any additional data of relevance (e.g., contrast dose, technical limitations, adverse events) are documented by the program 110 in the database 113, 114 in a Technologist Notes field of the imaging study.

9. After completion of the exam, the patient is transported back to the ER.

C. Radiologist: Interpretation and Reporting

1. The radiologist opens up the unread exam in order to initiate interpretation.

2. Before reviewing the imaging dataset, the radiologist reviews clinical data, which typically consists of a brief (i.e., few words) description of the clinical indication.

3. The radiologist also reviews any technologist notes which may have been entered along with the imaging dataset.

4. The radiologist reviews the historical imaging folder to identify prior imaging studies which may be relevant for comparison/correlation with the current imaging exam.

5. If any historical imaging studies are deemed relevant, the radiologist manually opens and reads the corresponding report(s).

6. After reading the reports, the radiologist manually opens up the corresponding imaging dataset to directly review the report findings.

7. The radiologist then opens the current imaging dataset and compares/correlates current and historical imaging findings.

8. After completing review of the entire imaging dataset(s), the radiologist creates a report by listing all pertinent findings on the current study and comparing them to historical report findings.

9. If any report findings are deemed to be emergent or unexpected, the radiologist is required to communicate these finding with the requesting clinician.

10. The radiologist may do so by either telephoning the physician directly, or recording the findings of interest and having an associate facilitate the communication (e.g., facsimile).

D. Physician: Clinical Management

1. After receipt of the radiology report (and any additional diagnostic data), the clinician makes a presumptive clinical diagnosis.

2. The clinician may opt to directly review the imaging dataset, which is manually performed by opening up the study, scrolling through the images, and attempting to identify and review the reported findings.

3. If questions relative to the radiology report remain, the clinician may initiate a consultation with the radiologist, which typically is performed via the telephone.

4. During the course of this consultation, additional clinical/imaging data may be shared between the two parties, which may provide improved clarity in rendering diagnosis.

5. Once the imaging report findings have been clarified, clinical orders are recorded in the EMR to further diagnosis and treatment.

6. If the radiologist desires additional clinical follow-up, manual review of the patient's EMR is required.

In order to automatically export key data from one information system technology to another, a bidirectional interface is created by the program 110. In the example of a radiologist interpreting a CT exam and creating a corresponding report, this interface is created by the program 110 between the PACS and the reporting system, which may be integrated. The typical workflow for a radiologist in CT interpretation includes navigating through the imaging dataset, using the program 110, in cine mode, with the speed at which images are sequentially displayed at the control of the radiologist. As he/she visualizes an area of pathology (i.e., abnormality) in the imaging dataset, an input command can be given to the program 110 to mark or annotate the anatomic region of interest. While manual input (e.g., mouse, stylus) would be the most common method of mark-up, alternative input methods such as speech or visual (e.g., eye tracking), can also be used to accomplish the task at hand.

Each time an image is marked or annotated (i.e., “marked”), an automated registration takes place using the program 110, on the corresponding database 113, 114, which in this example, takes the form of marking up a radiology report. In the most simplistic method of operation, a radiologist sequentially marks multiple areas of interest within the dataset, which customarily consists of pathologic findings (i.e., positive findings), but can also be used to denote normal findings (i.e., negative findings), which specifically address a significant clinical concern. Each image/finding which is marked, is then separately archived in the database 113, 114 and linked to the report, by the program 110. In this manner, an end-user reviewing the report has the option of reviewing the findings in both text and imaging formats.

In the present invention, the program 110 provides the means with which an imaging dataset can undergo segmentation, thereby automatically localizing the anatomic region of interest. This provides a convenient method with which input commands can automatically be translated by the program 110 into the anatomic region of interest. If for example, an input command highlights pathology with the right adrenal gland, the program 110 would automatically record the image and anatomic region being marked, in the database 113, 114. This data would be automatically recorded in the report database 113, 114 by the program 110, and the program 110 would then present it in itemized form on the corresponding radiology report. This provides a relatively easy-to-use mechanism to allow a radiologist to rapidly navigate through the imaging dataset, mark anatomic regions and images of concern, and have these images and structured text automatically populated by the program 110 on the report. Once the navigation and mark-up has been completed, an itemized list of findings (both positive and negative) is automatically captured by the program 110 on the report and can be embellished as needed. Using this technology provides a workflow efficient means of linking imaging and text data, identifying specific imaging findings for automated decision support, and direct integration of all marked findings into the report. This ensures that all identified findings will be directly recorded by the program 110 in the report and not subject to omission.

A number of finding-specific data can be directly incorporated by the program 110 into the report by customizing the annotation and mark-up being used. In the most simplistic form described, the radiologist inputs a command to mark all areas of interest, and the program 110 automatically records these itemized findings in the database 113, 114 according to the anatomic region or organ system, through segmentation analysis.

The radiologist can also use different annotation commands to differentiate findings based upon their importance (i.e., clinical significance). As an example, a single line or arrow denoting the region of interest can be expanded to a surrounding circle by the program 110, in the event that the finding in question is considered to be of high clinical significance and warrant immediate attention. In this manner, the input methodology used would vary in accordance with the manner in which the report data is to be categorized. This input customization can be expanded to the point of identifying specific pathologic findings or disease states according to the graphical symbol used for annotation (see U.S. Pat. No. 7,421,647, the contents of which are herein incorporated by reference in their entirety).

In one illustrative example, a radiologist interpreting an abdominal CT in the evaluation of suspected pancreatitis, is considered.

As the radiologist navigates (i.e., scrolls) through the imaging dataset presented by the program 110, he/she comes across several abnormal findings, which are identified by placing a mark over the specific region of image. This in turn causes the image to be automatically captured by the program 110 and the specific region of interest identified through segmentation. In some circumstances, multiple findings may be marked on a single image, which may or may not be contained within a single anatomic region. This could consist of a single image with abnormalities marked in the liver and adrenal gland (2 findings, 2 anatomic regions) or a single image with multiple abnormalities in a single organ (e.g., 2 distinct liver lesions). In either case, the program 110 would record in the report, the number of findings which are marked through end-user input.

A representative list of image-generated mark-up and report finding are as follows:

1. Right lung (+)

2. Liver 1 (+)

3. Liver 2 (+)

4. Left kidney (+)

5. Abdominal aorta (+)

6. Pancreas (−)

7. Prostate (+)

8. Sigmoid colon (+)

In this example, all findings listed are abnormal (i.e., positive), with the exception of the pancreas, which is reported as a negative (i.e., normal) finding due to its importance based upon the exam clinical indication. All other anatomic regions not listed (e.g., right kidney, left lung) would presumably be normal in the absence of reported findings, but would not have linked images by the program 110 for direct review.

The radiologist then elects to add whatever additional data to accompany the findings in the final report. In some circumstances, computerized decision support features can be used by the program 110 to automate additional finding-specific data, such as morphology, density, and size.

Once the input command identifies the finding of interest, computer-aided diagnosis (CAD) software can be used in/with the program 110 to automatically generate finding-specific data, which can be accepted or edited at the discretion of the radiologist, and integrated into the final report. Each individual end-user can have their own specific customized profile which directs which CAD programs are automatically utilized, once a finding specific input command has been generated.

In this particular example, the following findings have associated CAD analyses:
1. Right lung nodule: 7 mm, non-calcified, irregular borders, suspicious for malignancy
2. Liver lesion 1: 14 mm, low attention (2 HU), smooth margins, c/w cyst
3. Liver lesion 2: 10 mm, intermediate attenuation (46 HU), smooth margins, indeterminate etiology
4. Left kidney: 20 mm, low attenuation (10 HU), smooth margins, c/w cyst
5. Abdominal aorta: 3.5 cm, c/w aneurysm

The radiologist elects to save “as is” all data, in the database 113, 114, using the program 110, with several additions:
1. Right lung nodule: PET scan recommended.
2. Liver lesion 2: Follow-up CT in 3 months recommended

In addition, the radiologist adds the following finding specific data:
1. Prostate: Enlarged, 5.8 cm, with calcifications
2. Sigmoid colon: Diverticulosis, no peri-colonic inflammation
3. High priority: Right lung nodule, Liver lesion 2
4. Intermediate priority: Abdominal aorta
5. Low priority: Liver lesion 1, Left kidney, Prostate, Sigmoid colon

The final report is presented by the program 110 as follows:

Positive Findings:

High priority
1. Right lung nodule: 7 mm, non-calcified, irregular borders, suspicious for malignancy, PET scan recommended
2. Liver lesion 2: 10 mm, intermediate attenuation (46 HU), smooth margins, indeterminate etiology, Follow-up CT 3 months recommended
   Intermediate priority

Abdominal aorta: 3.5 cm, c/w aneurysm

Low Priority
1. Liver lesion 1: 14 mm, low attention (2 HU), smooth margins, c/w cyst
2. Left kidney: 20 mm, low attenuation (10 HU), smooth margins, c/w cyst
3. Prostate: Enlarged, 5.8 cm, with calcifications
4. Sigmoid colon: Diverticulosis, no peri-colonic inflammation

Negative Findings:

Pancreas

While the present invention ensures no observed findings go unreported, the present invention also provides the added value of directly linking report and imaging findings, as well as serving as a guide for automatically invoking computerized decision support tools, which can be directly integrated into the report. The final report is under the control of the authoring radiologist, who has the ability to edit any data contained in the final report database 113, 114. In the event that a finding is deleted from the final report, the corresponding image would also be deleted by the program 110. In this manner, only imaging data which directly maps to report data is saved and presented with the final report, by the program 110.

Another feature of the invention is the ability of the program 110 to integrate and capture data from other sources, which are intimately related to the imaging dataset. As an example, this can be related to the various steps which precede final imaging review and interpretation.
1. Clinical data
2. Image acquisition data
3. Historical imaging data

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A computer-implemented method of providing a multi-disciplinary interface to a user of a medical computer system, comprising:
capturing an image on a display screen of a computer system, in which a clinical finding is contained;
storing said image along with a descriptive textual presentation of said finding, in a report in a database of said computer system;
wherein said stored image includes an annotation schema which is customized to preferences of the user;
incorporating external data requirements from at least one of institutional requirements, community-based standards, and medical professionals in said report in said database;
reconciling data within said report with data contained within separate reports from other separate databases to determine data consistency; and
alerting the user using electronic communication means, of said data inconsistency and requesting reconciliation of said data inconsistency.

2. The computer-implemented method of claim 1, further comprising:
tracking data which is stored in any of said separate databases to determine consistency and accuracy between said separate databases.

3. The computer-implemented method of claim 1, further comprising:
recording prior imaging examination reports findings onto said report, along with any images, to create a new report.

4. The computer-implemented method of claim 3, wherein said prior imaging examination reports findings are automatically extracted and transposed onto said new report according to a predetermined relevance.

5. The computer-implemented method of claim 4, wherein said extraction is performed in real-time.

6. The computer-implemented method of claim 4, further comprising:
automatically transposing clinical data, of said external data requirements, provided by a clinician and integrating said clinical data into said report.

7. The computer-implemented method of claim 6, wherein said clinical data is at least one of numerical, textual, photographic, and graphical.

8. The computer-implemented method of claim 6, further comprising:
requiring the user to determine whether imaging examination report data received from an imaging examination, and stored in said database, addresses clinical indication data provided.

9. The computer-implemented method of claim 8, further comprising:
requiring reconciliation by the user when said imaging examination report data does not address said clinical indication data.

10. The computer-implemented method of claim 1, further comprising:
allowing multiple end-users to import data from said external data requirements, into said report.

11. The computer-implemented method of claim 10, wherein said end-users include clinicians, technologists, nurses, and administrators.

12. The computer-implemented method of claim 10, further comprising:
initiating consultation and communication with other users relative to said report.

13. The computer-implemented method of claim 12, further comprising:
tracking, analyzing, and storing in said database, all said consultations and communications during a lifetime of said report.

14. The computer-implemented method of claim 12, further comprising:
using electronic communication methods for communication to report critical results.

15. The computer-implemented method of claim 9, further comprising:
sorting and analyzing said clinical data and said imaging examination report data according to said findings, and according to end-user profiles and end-user performance.

16. The computer-implemented method of claim 1, wherein said end-user profiles include classifications based upon occupational status, practice type, institutional characteristics and individual characteristics.

17. A computer-readable medium whose contents cause a computer system to execute instructions of a program, the program comprising the steps of:
capturing an image on a display screen of a computer system, in which a clinical finding is contained;
storing said image along with a descriptive textual presentation of said finding, in a report in a database of said computer system;
wherein said stored image includes an annotation schema which is customized to preferences of the user;
incorporating external data requirements from at least one of institutional requirements, community-based standards, and medical professionals in said report in said database;
reconciling data within said report with data contained within separate reports from other separate databases to determine data consistency; and
alerting the user using electronic communication means, of said data inconsistency and requesting reconciliation of said data inconsistency.

18. A computer system which provides a multi-disciplinary interface to a user of a medical computer system, comprising:
at least one memory containing at least one program comprising the steps of:
capturing an image on a display screen of a computer system, in which a clinical finding is contained;
storing said image along with a descriptive textual presentation of said finding, in a report in a database of said computer system;
wherein said stored image includes an annotation schema which is customized to preferences of the user;
incorporating external data requirements from at least one of institutional requirements, community-based standards, and medical professionals in said report in said database;
reconciling data within said report with data contained within separate reports from other separate databases to determine data consistency; and
alerting the user using electronic communication means, of said data inconsistency and requesting reconciliation of said data inconsistency; and
at least one processor which executes the program.
